(19) United States
(12) Patent Application Publication
(10) Pub. No.: US 2018/0279319 A1
(43) Pub. Date: Sep. 27, 2018

(54) DYNAMIC PROVISIONING OF QUALITY OF SERVICE FOR END-TO-END QUALITY OF SERVICE CONTROL IN DEVICE-TO-DEVICE COMMUNICATION

(71) Applicant: Nokia Technologies Oy, Espoo (FI)

(72) Inventors: Ling YU, Kauniainen (FI); Dawid KOZIOL, Glogow (PL); Vinh VAN PHAN, Oulu (FI)

(21) Appl. No.: 15/914,169

(22) Filed: Mar. 7, 2018

Related U.S. Application Data
(60) Provisional application No. 62/475,381, filed on Mar. 23, 2017.

(51) Int. Cl. H04W 72/08; H04W 40/12

(52) U.S. Cl. CPC H04W 72/085; H04W 88/04; H04W 40/12

(57) ABSTRACT

Systems, methods, apparatuses, and computer program products for dynamic provisioning of quality of service (QoS) for end-to-end (E2E) QoS control in device-to-device (D2D) based UE-to-Network relay transmission are provided.

### BACKGROUND

### Field

Embodiments of the invention generally relate to wireless or mobile communications networks, such as, but not limited to, the Universal Mobile Telecommunications System (UMTS) Terrestrial Radio Access Network (UTRAN), Long Term Evolution (LTE) Evolved UTRAN (E-UTRAN), LTE-Advanced (LTE-A), LTE-A Pro, and/or 5G radio access technology or new radio access technology (NR). Some embodiments may generally relate device-to-device (D2D) communications integrated into such communications networks.

### Description of the Related Art

Universal Mobile Telecommunications System (UMTS) Terrestrial Radio Access Network (UTRAN) refers to a communications network including base stations, or Node Bs, and for example radio network controllers (RNC). UTRAN allows for connectivity between the user equipment (UE) and the core network. The RNC provides control functionalities for one or more Node Bs. The RNC and its corresponding Node Bs are called the Radio Network Subsystem (RNS). In case of E-UTRAN (enhanced UTRAN), no RNC exists and radio access functionality is provided by an evolved Node B (eNodeB or eNB) or many eNBs. Multiple eNBs are involved for a single UE connection, for example, in case of Coordinated Multipoint Transmission (CoMP) and in dual connectivity.

Long Term Evolution (LTE) or E-UTRAN refers to improvements of the UMTS through improved efficiency and services, lower costs, and use of new spectrum opportunities. In particular, LTE is a 3GPP standard that provides for uplink peak rates of at least, for example, 75 megabits per second (Mbps) per carrier and downlink peak rates of at least, for example, 300 Mbps per carrier. LTE supports scalable carrier bandwidths from 20 MHz down to 1.4 MHz and supports both Frequency Division Duplexing (FDD) and Time Division Duplexing (TDD).

As mentioned above, LTE may also improve spectral efficiency in networks, allowing carriers to provide more data and voice services over a given bandwidth. Therefore, LTE is designed to fulfill the needs for high-speed data and media transport in addition to high capacity voice support. Advantages of LTE include, for example, high throughput, low latency, FDD and TDD support in the same platform, an improved end-user experience, and a simple architecture resulting in low operating costs.

Certain releases of 3GPP LTE (e.g., LTE Rel-10, LTE Rel-11, LTE Rel-12, LTE Rel-13) are targeted towards international mobile telecommunications advanced (IMT-A) systems, referred to herein for convenience simply as LTE-Advanced (LTE-A).

LTE-A is directed toward extending and optimizing the 3GPP LTE radio access technologies. A goal of LTE-A is to provide significantly enhanced services by means of higher data rates and lower latency with reduced cost. LTE-A is a more optimized radio system fulfilling the international telecommunication union-radio (ITU-R) requirements for IMT-Advanced while maintaining backward compatibility. One of the key features of LTE-A, introduced in LTE Rel-10, is carrier aggregation, which allows for increasing the data rates through aggregation of two or more LTE carriers.

5^{th} generation (5G) or new radio (NR) wireless systems refer to the next generation (NG) of radio systems and network architecture. 5G is expected to provide higher bitrates and coverage than the current LTE systems. It is estimated that 5G will provide bitrates one hundred times higher than LTE offers. 5G is also expected to increase network expandability up to hundreds of thousands of connections. The signal technology of 5G is anticipated to be improved for greater coverage as well as spectral and signaling efficiency. 5G is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. In 5G or NR, the node B or eNB may be referred to as a next generation node B (gNB).

In addition, radio access network (RAN), such as LTE or 5G, may support hybrid modes of communication that provide both a cellular mode and a device-to-device (D2D) transmission mode. In a hybrid network, a UE may choose to communicate either via a cellular mode or a D2D transmission mode. As an example, a hybrid network may allow UEs to communicate either via a cellular mode (i.e., via a centralized controller such as an eNB or gNB) or via a D2D transmission mode where the UEs may establish a direct channel which may or may not be under the control of a centralized controller. The UE and/or its controlling network may make this selection depending on which mode provides better overall performance. Thus, a hybrid network may improve total system performance over a cellular network or an ad-hoc network (where UEs can only communicate with each other directly). However, in order to utilize a hybrid network, issues related to physical resource sharing and interference situations may need to be addressed.

In addition, proximity services (ProSe)/D2D discovery and communication is one of the ongoing work items for 3GPP Release 14 and beyond. ProSe refers to scenarios that could be provided by communications systems based on UEs being in proximity to each other. D2D scenarios that are currently being studied in 3GPP include D2D in network coverage, out of network coverage, and partial network coverage scenarios.

### SUMMARY

In a first aspect thereof the exemplary embodiments of this invention provide a method that comprises indicating, by a remote user equipment, quality of service information of at least one uplink packet in user plane or control plane to a relay user equipment or a network node wherein the quality of service information comprises at least one of a packet delay of the uplink packet transmitted over a device-to-device interface between the remote user equipment and the relay user equipment and a residual packet delay budget to be used for air interface transmission from the relay user equipment to the network mode.

In a further aspect thereof the exemplary embodiments of this invention provide an apparatus that comprises at least one data processor and at least one memory that includes computer program code. The at least one memory and computer program code are configured, with the at least one data processor, to cause the apparatus, at least to indicate, by the apparatus, quality of service information of at least one uplink packet in user plane or control plane to a relay user equipment or a network node wherein the quality of service information comprises at least one of a packet delay of the uplink packet transmitted over a device-to-device interface between the apparatus and the relay user equipment and a residual packet delay budget to be used for air interface transmission from the relay user equipment to the network mode.

In another aspect thereof the exemplary embodiments of this invention provide an apparatus that comprises at least one data processor and at least one memory that includes computer program code. The at least one memory and computer program code are configured, with the at least one data processor, to cause the apparatus, at least to indicate quality of service information of at least one downlink packet in user plane to a relay user equipment wherein the quality of service information of the downlink packet comprises waiting time and transmission delay of the downlink packet over air interface between the apparatus and the relay user equipment.

### BRIEF DESCRIPTION OF DRAWINGS

For proper understanding of the invention, reference should be made to the accompanying drawings, wherein:

FIG. 1a illustrates an example block diagram of an apparatus, according to one embodiment;

FIG. 1b illustrates an example block diagram of an apparatus, according to another embodiment;

FIG. 2 illustrates an example flow diagram of a method, according to an embodiment;

FIG. 3 illustrates an example flow diagram of a method, according to another embodiment; and

FIG. 4 illustrates an example flow diagram of a method, according to another embodiment.

### DETAILED DESCRIPTION

It will be readily understood that the components of the invention, as generally described and illustrated in the figures herein, may be arranged and designed in a wide variety of different configurations. Thus, the following detailed description of the embodiments of systems, methods, apparatuses, and computer program products for dynamic provisioning of quality of service (QoS) for end-to-end (E2E) QoS control in device-to-device (D2D) based UE-to-Network relay transmission, as represented in the attached figures and described below, is not intended to limit the scope of the invention but is representative of selected embodiments of the invention.

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments.

Additionally, if desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof.

Certain embodiments relate to 3GPP Rel-14 and beyond systems (e.g., 5G); but other embodiments may also be applicable to other radio technologies, such as wireless local area networks (WLAN). In particular, one embodiment is related to QoS control of Device-to-Device (D2D) communication based UE-to-Network relay. The D2D communication may also be known as SideLink (SL) communication or Proximity Services (ProSe) over PC5 interface.

A new study item (SI) [RP-161303] was started in 3GPP for further enhancement of LTE D2D (FeD2D) for internet of things (IoT) and wearable devices, in which the end-to-end (E2E) QoS support is required. 3GPP SI RP-161303 is incorporate herein by reference. It has been agreed that there are two main aspects that are to be further enhanced in LTE technology to enable D2D aided wearable and machine type communication (MTC) applications. These aspects include the enhancement of UE-to-Network relaying functionality, and enhancements to enable reliable unicast PC5 link to at least support low power, low rate and low complexity/cost devices.

In 3GPP Rel-13, ProSe per packet priority (PPPP) based priority handling solution was introduced for SL communication as a lightweight QoS control over the PC5 interface. There, PPPP is provided by the application layer and used by the access stratum (AS) to prioritize the SL transmission in respect with other SL transmissions either from the same or different UEs.

As 3GPP Rel-14 FeD2D study item requires E2E QoS support, the control of QoS while using indirect 3GPP communications based on PC5 sidelink should be comparable to that achieved while using direct 3GPP communications for the same service. The QoS class identifier (QCI) used as a main QoS indicator in direct 3GPP communication defines not only the priority but also other QoS parameters/attributes, such as packet delay budget (PDB) and packet error rate (PER). When considering D2D based UE-to-Network relay, the delay introduced by additional hop (i.e., SL communication) in a radio access network should be taken into account for e2e QoS control. The existing mechanism of providing QCI to the eNB and UE is not sufficient for e2e QoS control of the 2 hops radio access network transmission in UE-to-Network relay scenario, especially for UE autonomous resource allocation mode of the PC5/SL transmission.

In addition, the PDB in QCI only defines the upper bound of packet transmission delay. The real packet waiting and transmission time in either Uu or PC5 interface may depend on the priority of the packet, the link quality of the UE, the cell load or the load versus resource ratio, etc. It may be beneficial to take the real packet transmission time of one hop into account and adapt the packet delay budget of another link accordingly for more flexible and efficient resource allocation and QoS handling in the radio access network. Thus, certain embodiments address at least the problem of how to define and indicate the transmission delay of one link in more dynamic way to allow dynamic adaptation of the delay budget in another link in order to support E2E QoS in D2D based UE-to-Network relay solution.

An embodiment provides for a dynamic indication of PDB type of QoS parameters from a transmitting side to a receiving side of the first hop transmission in UE-to-Network relay scenario to facilitate QoS handling of the second hop of the transmission to ensure e2e QoS control.

According to an embodiment, a network node (e.g., eNB or gNB) may indicate the PDB information of the downlink (DL) packet in the user plane (UP) to the relay UE so that the corresponding PDB used for PC5 transmission can be derived. In one embodiment, the PDB information of DL packet(s) may include the waiting time and transmission delay of the data packet over the Uu interface between the network node (e.g., eNB/gNB) and the relay UE. The relay UE may derive the PDB for PC5 transmission based on a network configuration (e.g. QCI) and the indicated PDB of the packet transmitted over the Uu interface. In another embodiment, the eNB may derive the PDB used for PC5 transmission based on QCI and the estimated packet transmission time over the Uu interface and indicate the PDB of PC5 to the relay UE.

In one embodiment, the PDB information may be indicated in a Uu adaptation layer header. In this case, the PDB for PC5 may be different for each packet of the same radio bearer having the same QCI. This embodiment allows more efficient and flexible resource allocation on PC5 based on the real PDB required for PC5 transmission. In another embodiment, the PDB information may be indicated as adaptation layer control Protocol Data Unit (C-PDU). In this case, the PDB C-PDU may be sent when the QCI or estimated transmission time over the Uu interface has changed. This embodiment provides lower overhead when packet transmission time over the Uu interface does not change rapidly on a per-packet basis.

According to an embodiment, the remote UE may indicate the PDB information of the uplink (UL) packet in the UP or control plane (CP) to a relay UE or network node (e.g., eNB/gNB) so that the corresponding PDB used for the Uu transmission can be derived by the eNB. In one embodiment, the PDB information of the UL packet may be the packet delay of the data transmitted over PC5 interface between the remote and relay UE. In another embodiment, the PDB information of the UL packet may be the residual PDB to be used for Uu transmission from the relay UE to the network node (e.g., eNB/gNB). The remote UE may derive the residual PDB based on a network configuration (e.g., QCI) and estimated transmission delay over the PC5.

In one embodiment, the PDB information of the UL packet may be sent to the network node (e.g., eNB/gNB) as the PDCP C-PDU. The PDCP C-PDU for PDB of UL packet may be sent when the estimated transmission delay over the PC5 or QCI has changed. In another embodiment, the PDB information of the UL packet may be sent to the eNB as the CP signalling. In this case, the network node (e.g., eNB/gNB) may schedule the relayed UL data from the relay UE by taking into account the reported PDB information of the UL packet.

In one embodiment, the PDB information of the UL packet may be sent to the relay UE in PC5 adaptation layer or RLC layer either in the PDU header or as corresponding protocol layer C-PDU. Upon receiving the PDB information of the UL packet, the relay UE may report the PDB information either as adaptation layer C-PDU or medium access control (MAC) control element (CE) buffer status report (BSR). For the latter, the mapping of the reported BSR and logical channels may take into account the PDB information.

As outlined above, embodiments of the present disclosure allow for flexible and dynamic PDB management for indirect 3GPP communications, for example in case the packet needs to traverse an intermediate node (e.g., UE-to-Network Relay) to reach its final destination. This is achieved by providing means to indicate the transmission delay of one of the links in a dynamic way to allow for dynamic adaptation of the delay budget in another link Such an approach ensures that E2E QoS in D2D based UE-to-Network relay solution is met, but at the same time avoids unnecessarily inflated PDB requirements for each of the links.

For a DL packet, the Uu adaptation layer may add the PDB information in the adaptation layer PDU header or use C-PDU to indicate the PDB information. For both options, the list of the PDB values may be configured by the network node, such as an eNB or gNB, during relaying or relayed radio bearer configuration. Indicated PDB information in the PDU header or C-PDU is the index of the PDB in the configured list.

For a UL packet, a similar list of the PDB values may be configured to a remote UE so that the remote UE can use the index of the PDB in the list to indicate the UL PDB information either in C-PDU or PC5 adaptation layer PDU header. In addition, the network node (e.g., eNB or gNB) may also configure the remote UE the target/maximum SL-PDB that the remote UE should target for SL transmission to the relay UE. The target/maximum SL-PDB may be configured either explicitly as standalone Information Element (IE) or implicitly as the first or last PDB index.

Another option may be to include a timestamp (e.g., based on global navigation satellite system (GNSS) timing) in the PDU header. Based on the timestamp in the received packet and/or a (pre-)configured PDB information, a relay UE may derive the residual PDB for PC5 interface (DL direction) or Uu interface (UL direction).

For the option that UL PDB information is provided to the relay UE by remote UE in PC5 C-PDU, the relay UE may forward the PDB information using Uu adaptation layer C-PDU or CP signalling (e.g. radio resource control (RRC) UEAssistancelnformation message) to the network node (e.g., eNB or gNB) so that the network node can schedule the relayed UL packet by taking into account the reported/indicated PDB information from the relay UE.

For the option that UL PDB information is provided to the relay UE by remote UE in PC5 PDU header, the relay UE may report the PDB information implicitly with MAC CE BSR. One example embodiment is that the network node may configure the logical channel to logical channel group mapping based on the PDB. In other words, the mapping of the logical channel to the logical channel group for BSR may depend on the PDB information that is indicated by the remote UE in the PDU header. As one example, the same logical channel may be mapped to logical channel group 1 when the residual PDB is 50 ms, to logical channel group 2 when the residual PDB is 200 ms, and so on. Based on the configuration and the PDB information indicated by the remote UE, the relay UE can report BSR in the corresponding logical channel group so that the network node can schedule the UL transmission accordingly.

For the option that UL PDB information is provided/reported to the network node via CP signalling, a new IE of UL-SL-PDB may be introduced to the RRC UEAssistancelnformation message for UL PDB information report.

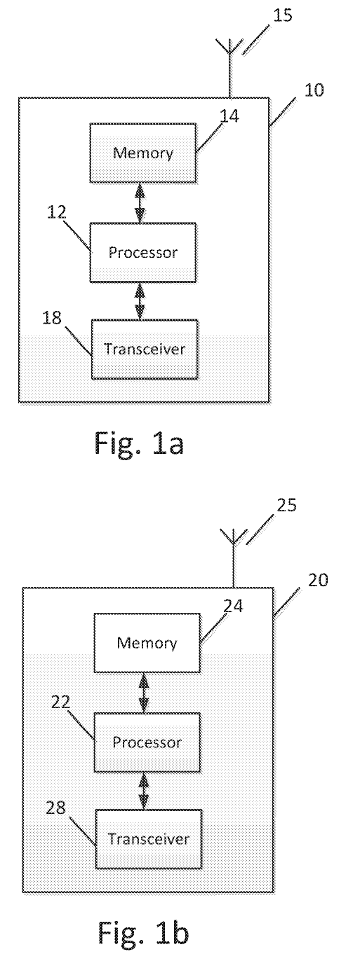

FIG. 1a illustrates an example of an apparatus 10 according to an embodiment. In an embodiment, apparatus 10 may be a node, host, or server in a communications network or serving such a network. For example, apparatus 10 may be a base station, a node B, an evolved node B, 5G node B or access point, next generation node B (NG-NB or gNB), WLAN access point, mobility management entity (MME), or subscription server associated with a radio access network, such as a GSM network, LTE network, 5G or NR. It should be understood that apparatus 10 may be comprised of an edge cloud server as a distributed computing system where the server and the radio node may be stand-alone apparatuses communicating with each other via a radio path or via a wired connection, or they may be located in a same entity communicating via a wired connection. It should be noted that one of ordinary skill in the art would understand that apparatus 10 may include components or features not shown in FIG. 1a.

As illustrated in FIG. 1a, apparatus 10 may include a processor 12 for processing information and executing instructions or operations. Processor 12 may be any type of general or specific purpose processor. While a single processor 12 is shown in FIG. 1a, multiple processors may be utilized according to other embodiments. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Processor 12 may perform functions associated with the operation of apparatus 10 which may include, for example, precoding of antenna gain/phase parameters, encoding and decoding of individual bits forming a communication message, formatting of information, and overall control of the apparatus 10, including processes related to management of communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink). As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly.

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

In certain embodiments, apparatus 10 may be a network node or RAN node, such as a base station, access point, node B, eNB, 5G or new radio node B (gNB) or access point, WLAN access point, or the like. According to certain embodiments, apparatus 10 may be controlled by memory 14 and processor 12 to perform the functions associated with embodiments described herein. For example, in one embodiment, apparatus 10 may be controlled by memory 14 and processor 12 to indicate PDB information of one or more DL packet(s) in the UP to a relay UE, for example, so that the corresponding PDB used for PC5 transmission can be derived. In an embodiment, the PDB information of DL packet(s) may include the waiting time and transmission delay of the data packet over the Uu interface between apparatus 10 and the relay UE. According to one embodiment, the relay UE may derive the PDB for PC5 transmission based on network configuration (e.g., QCI) and the indicated PDB of the packet transmitted over the Uu interface. In another embodiment, apparatus 10 may be controlled by memory 14 and processor 12 to derive the PDB used for PC5 transmission based on the QCI and the estimated packet transmission time over the Uu, and to indicate the PDB of PC5 to the relay UE.

In one embodiment, apparatus 10 may be controlled by memory 14 and processor 12 to indicate the PDB information in a Uu adaptation layer header. In this case, the PDB for PC5 may be different for each packet of the same radio bearer having the same QCI. This embodiment results in more efficient and flexible resource allocation on PC5 based on the real PDB required for PC5 transmission. In another embodiment, apparatus 10 may be controlled by memory 14 and processor 12 to indicate the PDB information as an adaptation layer C-PDU. In this case, apparatus 10 may be controlled by memory 14 and processor 12 to send the PDB C-PDU when the QCI or estimated transmission time over the Uu interface has changed. This embodiment provides lower overhead when packet transmission time over the Uu does not change rapidly on per-packet basis.

FIG. 1b illustrates an example of an apparatus 20 according to another embodiment. In an embodiment, apparatus 20 may be a node or element in a communications network or associated with such a network, such as a UE, mobile equipment (ME), mobile station, mobile device, stationary device, IoT device, or other device. As described herein, UE may alternatively be referred to as, for example, a mobile station, mobile equipment, mobile unit, mobile device, user device, subscriber station, wireless terminal, tablet, smart phone, IoT device or NB-IoT device, or the like. As one example, Apparatus 20 may be implemented in, for instance, a wireless handheld device, a wireless plug-in accessory, or the like.

In some example embodiments, apparatus 20 may include one or more processors, one or more computer-readable storage medium (for example, memory, storage, and the like), one or more radio access components (for example, a modem, a transceiver, and the like), and/or a user interface. In some embodiments, apparatus 20 may be configured to operate using one or more radio access technologies, such as GSM, NB-IoT, LTE, LTE-A, 5G, WLAN, WiFi, Bluetooth, NFC, and any other radio access technologies. It should be noted that one of ordinary skill in the art would understand that apparatus 20 may include components or features not shown in FIG. 1b.

As illustrated in FIG. 1b, apparatus 20 may include or be coupled to a processor 22 for processing information and executing instructions or operations. Processor 22 may be any type of general or specific purpose processor. While a single processor 22 is shown in FIG. 1b, multiple processors may be utilized according to other embodiments. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Processor 22 may perform functions associated with the operation of apparatus 20 including, without limitation, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 24 can be comprised of any combination of random access memory (RAM), read only memory (ROM), static storage such as a magnetic or optical disk, or any other type of non-transitory machine or computer readable media. The instructions stored in memory 24 may include program instructions or computer program code that, when executed by processor 22, enable the apparatus 20 to perform tasks as described herein.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, NB-IoT, LTE, LTE-A, 5G, WLAN, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

According to one embodiment, apparatus 20 may be a UE, mobile device, mobile station, ME, IoT device and/or NB-IoT device, for example. According to certain embodiments, apparatus 20 may be controlled by memory 24 and processor 22 to perform the functions associated with embodiments described herein.

In one embodiment, apparatus 20 may be a relay UE in a D2D UE-to-Network relay scenario, for example. In this embodiment, apparatus 20 may be controlled by memory 24 and processor 22 to receive an indication of QoS information of one or more DL packet(s) in the UP from a network node (e.g., eNB, gNB, or WLAN AP), for example, so that the corresponding PDB used for PC5 transmission can be derived. According to one embodiment, the QoS information may be or may include PDB information, for example. In an embodiment, the PDB information of DL packet(s) may include the waiting time and transmission delay of the data packet over the Uu interface between the network node and apparatus 20. According to one embodiment, apparatus 20 may then be controlled by memory 24 and processor 22 to derive the PDB for PC5 transmission based on network configuration (e.g., QCI) and the indicated PDB of the packet transmitted over the Uu interface. In another embodiment, the network node may derive the PDB used for PC5 transmission based on the QCI and the estimated packet transmission time over the Uu interface, and apparatus 20 may be controlled by memory 24 and processor 22 to receive an indication of the PDB of PC5 from the network node. In another embodiment, apparatus 20 may be controlled by memory 24 and processor 22 to receive the PDB information of the UL packet, from the remote UE, in PC5 adaptation layer or RLC layer either in the PDU header or as corresponding protocol layer C-PDU. Upon receiving the PDB information of the UL packet, apparatus 20 may be controlled by memory 24 and processor 22 to report the PDB information either as adaptation layer C-PDU or MAC CE buffer status report (BSR). For the latter, the mapping of the reported BSR and logical channels may take into account the PDB information.

In another embodiment, apparatus 20 may be a remote UE in a D2D UE-to-Network relay scenario, for example. As one example, apparatus 20 may be an IoT device or wearable device. In this embodiment, apparatus 20 may be controlled by memory 24 and processor 22 to indicate PDB information of one or more UL packet(s) in the UP or CP to a relay UE or network node, for example, so that the corresponding PDB used for Uu transmission can be derived by the network node.

In one embodiment, the PDB information of the UL packet may include the packet delay of the data transmitted over the PC5 interface between apparatus 20 and the relay UE. In an embodiment, the PDB information of the UL packet may include the residual PDB to be used for Uu transmission from the relay UE to the network node. According to one embodiment, apparatus 20 may be controlled by memory 24 and processor 22 to derive the residual PDB based on network configuration (e.g., QCI) and estimated transmission delay over the PC5.

In an embodiment, apparatus 20 may be controlled by memory 24 and processor 22 to send the PDB information of the UL packet, to the network node, as the PDCP C-PDU. For example, in one embodiment, apparatus 20 may be controlled by memory 24 and processor 22 to send the PDCP C-PDU for PDB of UL packet when the estimated transmission delay over the PC5 or QCI has changed. In another embodiment, apparatus 20 may be controlled by memory 24 and processor 22 to send the PDB information of the UL packet, to the network node, as the CP signalling. In this case, the network node may schedule the relayed UL data from the relay UE by taking into account the reported PDB information of the UL packet.

In one embodiment, apparatus 20 may be controlled by memory 24 and processor 22 to send the PDB information of the UL packet to the relay UE in PC5 adaptation layer or RLC layer either in the PDU header or as corresponding protocol layer C-PDU. Upon receiving the PDB information of the UL packet, the relay UE may report the PDB information either as adaptation layer C-PDU or MAC CE buffer status report (BSR). For the latter, the mapping of the reported BSR and logical channels may take into account the PDB information.

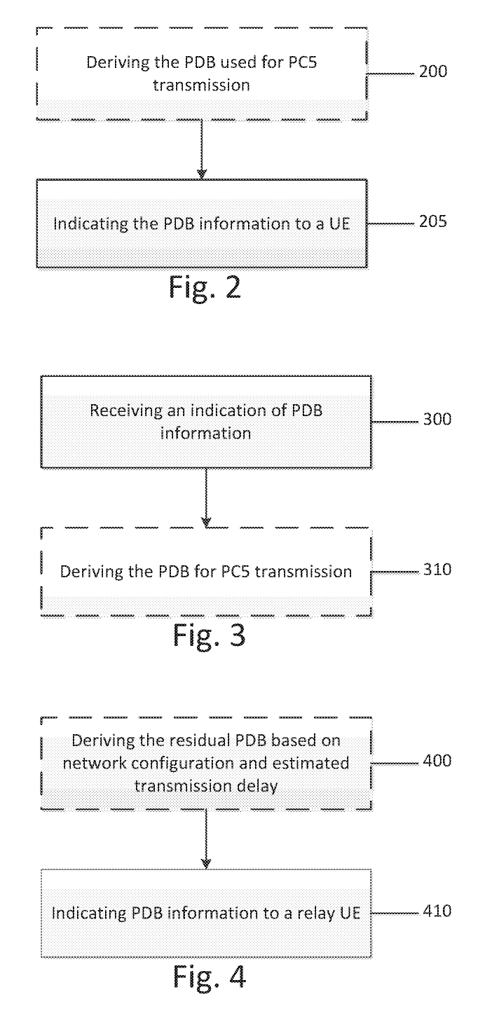

FIG. 2 illustrates an example flow diagram of a method, according to one embodiment. The method of FIG. 2 may be performed, for example, by a network node, such as a base station, access point, eNB, gNB, or the like. As illustrated in FIG. 2 the method may include, at 205, indicating QoS information of one or more DL packet(s) in the UP to a relay UE, for example, so that the corresponding PDB used for PC5 transmission can be derived. According to one embodiment, the QoS information may be or may include PDB information, for example. In an embodiment, the PDB information of DL packet(s) may include the waiting time and transmission delay of the data packet over the Uu interface between the network node and the relay UE. According to one embodiment, the relay UE may then derive the PDB for PC5 transmission based on network configuration (e.g., QCI) and the indicated PDB of the packet transmitted over the Uu interface. In another embodiment, the method may include, at 200, deriving the PDB used for PC5 transmission based on the QCI and the estimated packet transmission time over the Uu, and then indicating, at 205, the PDB of PC5 to the relay UE.

In one embodiment, the indicating 205 may include indicating the PDB information in a Uu adaptation layer header. In this case, the PDB for PC5 may be different for each packet of the same radio bearer having the same QCI. In another embodiment, the indicating 205 may include indicating the PDB information as an adaptation layer C-PDU. In this case, the indicating 205 may include sending the PDB C-PDU when the QCI or estimated transmission time over the Uu interface has changed.

FIG. 3 illustrates an example flow diagram of a method, according to one embodiment. The method of FIG. 3 may be performed, for example, by a UE, mobile station, mobile device, IoT device, wearable device, or the like. In one example embodiment, the method of FIG. 3 may be performed by a relay UE in a D2D UE-to-Network relay scenario, for example. As illustrated in FIG. 3 the method may include, at 300, receiving an indication of QoS information of one or more DL packet(s) in the UP from a network node (e.g., eNB, gNB, or WLAN AP), for example, so that the corresponding PDB used for PC5 transmission can be derived. According to one embodiment, the QoS information may be or may include PDB information, for example. In an embodiment, the PDB information of DL packet(s) may include the waiting time and transmission delay of the data packet over the Uu interface between the network node and the relay UE. According to one embodiment, the method may then include, at 310, deriving the PDB for PC5 transmission. In one example, the deriving 310 may include deriving the PDB for PC5 transmission based on network configuration (e.g., QCI) and the indicated PDB of the packet transmitted over the Uu interface. In another embodiment, the network node may derive the PDB used for PC5 transmission based on the QCI and the estimated packet transmission time over the Uu interface, and the method may include, at 300, receiving an indication of the PDB of PC5 from the network node.

In another embodiment, the method may include receiving the PDB information of the UL packet, from a remote UE, in PC5 adaptation layer or RLC layer either in the PDU header or as corresponding protocol layer C-PDU. Upon receiving the PDB information of the UL packet, the method may include reporting the PDB information either as adaptation layer C-PDU or MAC CE buffer status report (BSR). For the MAC CE BSR, the mapping of the reported BSR and logical channels may take into account the PDB information.

FIG. 4 illustrates an example flow diagram of a method, according to one embodiment. The method of FIG. 4 may be performed, for example, by a UE, mobile station, mobile device, IoT device, wearable device, or the like. In one example embodiment, the method of FIG. 4 may be performed by a remote UE in a D2D UE-to-Network relay scenario, for example. As illustrated in FIG. 4 the method may include, at 410, indicating QoS information of one or more UL packet(s) in the UP or CP to a relay UE or network node, for example, so that the corresponding PDB used for Uu transmission can be derived by the network node. According to one embodiment, the QoS information may be or may include PDB information, for example.

In one embodiment, the PDB information of the UL packet may include the packet delay of the data transmitted over the PC5 interface between the remote UE and the relay UE. In an embodiment, the PDB information of the UL packet may include the residual PDB to be used for Uu transmission from the relay UE to the network node. According to one embodiment, the method may include, at 400, deriving the residual PDB based on network configuration (e.g., QCI) and estimated transmission delay over the PC5.

In an embodiment, the indicating 410 may include sending the PDB information of the UL packet, to the network node, as the PDCP C-PDU. For example, in one embodiment, the method may include sending the PDCP C-PDU for PDB of UL packet when the estimated transmission delay over the PC5 or QCI has changed. In another embodiment, the indicating 410 may include sending the PDB information of the UL packet, to the network node, as the CP signalling. In this case, the network node may schedule the relayed UL data from the relay UE by taking into account the reported PDB information of the UL packet.

In one embodiment, the indicating 410 may include sending the PDB information of the UL packet to the relay UE in PC5 adaptation layer or RLC layer either in the PDU header or as corresponding protocol layer C-PDU. Upon receiving the PDB information of the UL packet, the relay UE may report the PDB information either as adaptation layer C-PDU or MAC CE buffer status report (BSR). For the MAC CE BSR option, the mapping of the reported BSR and logical channels may take into account the PDB information.

In view of the above, embodiments of the invention provide several technical improvements and/or advantages. For example, certain embodiments provide for flexible and dynamic PDB management for indirect 3GPP communications, e.g., in case a packet needs to traverse an intermediate node to reach its destination. For example, certain embodiments described herein can ensure that E2E QoS in D2D based UE-to-Network relay solution is met, and at the same time avoids unnecessarily inflated PDB requirements for each of the links. As such, embodiments of the invention can improve performance and throughput of network nodes including, for example, base stations, eNBs, gNBs and/or UEs. Accordingly, the use of embodiments of the invention result in improved functioning of communications networks and their nodes.

In some embodiments, the functionality of any of the methods, processes, signaling diagrams, or flow charts described herein may be implemented by software and/or computer program code or portions of code stored in memory or other computer readable or tangible media, and executed by a processor.

In certain embodiments, an apparatus may be included or be associated with at least one software application, module, unit or entity configured as arithmetic operation(s), or as a program or portions of it (including an added or updated software routine), executed by at least one operation processor. Programs, also called computer program products or computer programs, including software routines, applets and macros, may be stored in any apparatus-readable data storage medium and include program instructions to perform particular tasks.

A computer program product may comprise one or more computer-executable components which, when the program is run, are configured to carry out embodiments described herein. The one or more computer-executable components may include at least one software code or portions of code. Modifications and configurations required for implementing the functionality of an embodiment may be performed as routine(s), which may be implemented as added or updated software routine(s). In some embodiments, software routine(s) may be downloaded into the apparatus.

Software or a computer program code or portions of code may be in a source code form, object code form, or in some intermediate form, and may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and/or software distribution package, for example. Depending on the processing power needed, the computer program may be executed in a single electronic digital device or it may be distributed amongst a number of devices or computers. The computer readable medium or computer readable storage medium may be a non-transitory medium.

In other embodiments, the functionality may be performed by hardware, for example through the use of an application specific integrated circuit (ASIC), a programmable gate array (PGA), a field programmable gate array (FPGA), or any other combination of hardware and software. In yet another embodiment, the functionality may be implemented as a signal, a non-tangible means that can be carried by an electromagnetic signal downloaded from the Internet or other network.

According to an embodiment, an apparatus, such as a node, device, or a corresponding component, may be configured as a computer or a microprocessor, such as single-chip computer element, or as a chipset, including at least a memory for providing storage capacity used for arithmetic operation(s) and an operation processor for executing the arithmetic operation.

One embodiment is directed to a method that may include indicating, by a network node, QoS information of one or more DL packet(s) in the UP to a relay UE. In an embodiment, the QoS information of DL packet(s) may include the waiting time and transmission delay of the data packet over the Uu interface between the network node and the relay UE. In another embodiment, the method may include, for example before indicating the QoS information, deriving the PDB used for PC5 transmission based on a QCI and the estimated packet transmission time over the Uu, and then indicating the PDB of PC5 to the relay UE. In one embodiment, the indicating may include indicating the QoS information in a Uu adaptation layer PDU header. In another embodiment, the indicating may include indicating the QoS information as an adaptation layer C-PDU, for example, when the QCI or estimated transmission time over the Uu interface has changed. According to an embodiment, the QoS information may include PDB information, for example.

Another embodiment is directed to an apparatus that may include at least one processor and at least one memory including computer program code. The at least one memory and the computer program code may be configured, with the at least one processor, to cause the apparatus at least to indicate QoS information of one or more DL packet(s) in the UP to a relay UE. In an embodiment, the QoS information of DL packet(s) may include the waiting time and transmission delay of the data packet over the Uu interface between the apparatus and the relay UE. In another embodiment, the at least one memory and the computer program code may be configured, with the at least one processor, to cause the apparatus at least to derive the PDB used for PC5 transmission based on a QCI and the estimated packet transmission time over the Uu, and then to indicate the PDB of PC5 to the relay UE. In one embodiment, the at least one memory and the computer program code may be configured, with the at least one processor, to cause the apparatus at least to indicate the QoS information in a Uu adaptation layer PDU header. In another embodiment, the at least one memory and the computer program code may be configured, with the at least one processor, to cause the apparatus at least to indicate the QoS information as an adaptation layer C-PDU, for example, when the QCI or estimated transmission time over the Uu interface has changed. According to an embodiment, the QoS information may include PDB information, for example.

Another embodiment is directed to a method that may include receiving, at a relay UE, an indication of QoS information of one or more DL packet(s) in the UP from a network node. In an embodiment, the QoS information of DL packet(s) may include the waiting time and transmission delay of the data packet over the Uu interface between the network node and the relay UE. According to one embodiment, the method may then include deriving the PDB for PC5 transmission. In one example, the deriving may include deriving the PDB for PC5 transmission based on network configuration (e.g., QCI) and the indicated PDB of the packet transmitted over the Uu interface. In another embodiment, the network node may derive the PDB used for PC5 transmission based on the QCI and the estimated packet transmission time over the Uu interface, and the method may include receiving an indication of the PDB of PC5 from the network node. In another embodiment, the method may include receiving the QoS information of a UL packet, from a remote UE, in PC5 adaptation layer or RLC layer either in the PDU header or as corresponding protocol layer C-PDU. Upon receiving the QoS information of the UL packet, the method may include reporting the QoS information either as adaptation layer C-PDU or MAC CE BSR. According to an embodiment, the QoS information may include PDB information, for example.

Another embodiment is directed to an apparatus that may include at least one processor and at least one memory including computer program code. The at least one memory and the computer program code are configured, with the at least one processor, to cause the apparatus at least to receive an indication of QoS information of one or more DL packet(s) in the UP from a network node. In an embodiment, the QoS information of DL packet(s) may include the waiting time and transmission delay of the data packet over the Uu interface between the network node and the apparatus. According to one embodiment, the at least one memory and the computer program code may be configured, with the at least one processor, to cause the apparatus at least to derive the PDB for PC5 transmission. In one example, the apparatus may be controlled to derive the PDB for PC5 transmission based on network configuration (e.g., QCI) and the indicated PDB of the packet transmitted over the Uu interface. In another embodiment, the network node may derive the PDB used for PC5 transmission based on the QCI and the estimated packet transmission time over the Uu interface, and the at least one memory and the computer program code may be configured, with the at least one processor, to cause the apparatus at least to receive an indication of the PDB of PC5 from the network node. In another embodiment, the at least one memory and the computer program code may be configured, with the at least one processor, to cause the apparatus at least to receive the QoS information of a UL packet, from a remote UE, in PC5 adaptation layer or RLC layer either in the PDU header or as corresponding protocol layer C-PDU. Upon receiving the QoS information of the UL packet, the at least one memory and the computer program code may be configured, with the at least one processor, to cause the apparatus at least to report the QoS information either as adaptation layer C-PDU or MAC CE BSR. According to an embodiment, the QoS information may include PDB information, for example.

Another embodiment is directed to a method that may include indicating, by a remote UE, QoS information of one or more UL packet(s) in the UP or CP to a relay UE or network node. In one embodiment, the QoS information of the UL packet may include the packet delay of the data transmitted over the PC5 interface between the remote UE and the relay UE. In an embodiment, the QoS information of the UL packet may include the residual PDB to be used for Uu transmission from the relay UE to the network node. According to one embodiment, the method may include deriving the residual PDB based on network configuration (e.g., QCI) and estimated transmission delay over the PC5. According to an embodiment, the QoS information may include PDB information, for example.

In an embodiment, the indicating may include sending the QoS information of the UL packet, to the network node, as the PDCP C-PDU. For example, in one embodiment, the method may include sending the PDCP C-PDU for PDB of UL packet when the estimated transmission delay over the PC5 or QCI has changed. In another embodiment, the indicating may include sending the QoS information of the UL packet, to the network node, as the CP signalling. In one embodiment, the indicating may include sending the QoS information of the UL packet to the relay UE in PC5 adaptation layer or RLC layer either in the PDU header or as corresponding protocol layer C-PDU. In one embodiment, the mapping of the reported BSR and logical channels may take into account the QoS information.

Another embodiment is directed to an apparatus that may include at least one processor and at least one memory including computer program code. The at least one memory and the computer program code may be configured, with the at least one processor, to cause the apparatus at least to indicate QoS information of one or more UL packet(s) in the UP or CP to a relay UE or network node. In one embodiment, the QoS information of the UL packet may include the packet delay of the data transmitted over the PC5 interface between the apparatus and the relay UE. In an embodiment, the QoS information of the UL packet may include the residual PDB to be used for Uu transmission from the relay UE to the network node. According to one embodiment, the at least one memory and the computer program code may be configured, with the at least one processor, to cause the apparatus at least to derive the residual PDB based on network configuration (e.g., QCI) and estimated transmission delay over the PC5. According to an embodiment, the QoS information may include PDB information, for example.

In an embodiment, the at least one memory and the computer program code may be configured, with the at least one processor, to cause the apparatus at least to send the QoS information of the UL packet, to the network node, as the PDCP C-PDU. For example, in one embodiment, the at least one memory and the computer program code may be configured, with the at least one processor, to cause the apparatus at least to send the PDCP C-PDU for PDB of UL packet when the estimated transmission delay over the PC5 or QCI has changed. In another embodiment, the at least one memory and the computer program code may be configured, with the at least one processor, to cause the apparatus at least to send the QoS information of the UL packet, to the network node, as the CP signalling. In one embodiment, the at least one memory and the computer program code may be configured, with the at least one processor, to cause the apparatus at least to send the QoS information of the UL packet to the relay UE in PC5 adaptation layer or RLC layer either in the PDU header or as corresponding protocol layer C-PDU. In one embodiment, the mapping of the reported BSR and logical channels may take into account the QoS information.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

What is claimed is:

1. A method comprising:
indicating, by a remote user equipment, quality of service information of at least one uplink packet in user plane or control plane to a relay user equipment or a network node wherein the quality of service information comprises at least one of a packet delay of the uplink packet transmitted over a device-to-device interface between the remote user equipment and the relay user equipment and a residual packet delay budget to be used for air interface transmission from the relay user equipment to the network node.

2. The method as in claim 1, further comprising:
deriving the residual packet delay budget based on a quality of service class identifier and estimated transmission delay over the device-to-device interface.

3. The method as in claim 1, wherein the quality of service information of the uplink packet is sent to the network node using a packet data convergence protocol control protocol data unit.

4. The method as in claim 3, wherein the packet data convergence protocol control protocol data unit is sent when estimated transmission delay over the device-to-device interface or quality of service class identifier has changed.

5. The method as in claim 1, wherein the quality of service information of the uplink packet is sent to the network node using a control plane signaling.

6. The method as in claim 1, wherein the quality of service information of the uplink packet is sent to the relay user equipment in adaptation layer or radio link control layer of the device-to-device interface.

7. The method as in claim 6, wherein the quality of service information of the uplink packet to the relay user equipment is sent in protocol data unit header or as a control protocol data unit.

8. An apparatus, comprising:
at least one processor; and
at least one memory including compute program instructions,
wherein the at least one memory and computer program instructions are configured to, with the at least one processor, cause the apparatus at least to:
indicate, by the apparatus, quality of service information of at least one uplink packet in user plane or control plane to a relay user equipment or a network node wherein the quality of service information comprises at least one of a packet delay of the uplink packet transmitted over a device-to-device interface between the apparatus and the relay user equipment and a residual packet delay budget to be used for air interface transmission from the relay user equipment to the network node.

9. The apparatus as in claim 8, wherein the at least one memory and computer program instructions are further configured to, with the at least one processor, cause the apparatus at least to:
derive the residual packet delay budget based on a quality of service class identifier and estimated transmission delay over the device-to-device interface.

10. The apparatus as in claim 8, wherein the quality of service information of the uplink packet is sent to the network node using a packet data convergence protocol control protocol data unit.

11. The apparatus as in claim 10, wherein the packet data convergence protocol control protocol data unit is sent when estimated transmission delay over the device-to-device interface or quality of service class identifier has changed.

12. The apparatus as in claim 8, wherein the quality of service information of the uplink packet is sent to the network node using a control plane signaling.

13. The apparatus as in claim 8, wherein the quality of service information of the uplink packet is sent to the relay user equipment in adaptation layer or radio link control layer of the device-to-device interface.

14. The apparatus as in claim 13, wherein the quality of service information of the uplink packet to the relay user equipment is sent in protocol data unit header or as a control protocol data unit.

15. An apparatus, comprising:
at least one processor; and
at least one memory including compute program instructions,
wherein the at least one memory and computer program instructions are configured to, with the at least one processor, cause the apparatus at least to:
indicate quality of service information of at least one downlink packet in user plane to a relay user equipment wherein the quality of service information of the downlink packet comprises waiting time and transmission delay of the downlink packet over air interface between the apparatus and the relay user equipment.

16. The apparatus as in claim 15, wherein the at least one memory and computer program instructions are further configured to, with the at least one processor, cause the apparatus at least to:
derive a packet delay budget used for device-to-device interface transmission based on a quality of service class identifier and an estimated packet transmission time over the air interface; and
indicate the packet delay budget of the device-to-device interface to the relay user equipment.

17. The apparatus as in claim 15, wherein the quality of service information is sent in the air interface adaptation layer protocol data unit header.

18. The apparatus as in claim 15, wherein the quality of service information is sent as an adaptation layer control protocol data unit.

19. The apparatus as in claim 18, wherein the control protocol data unit is sent when quality of service class identifier or estimated transmission time over the air interface has changed.

20. The apparatus as in claim 15, wherein the quality of service information comprises packet delay budget information.
